(19) United States
(12) Patent Application Publication
(10) Pub. No.: US 2007/0208747 A1
(43) Pub. Date: Sep. 6, 2007

(54) Mutual Contacts Discovery

(75) Inventor: Shaun Puckrin, Kent (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMBIAN SOFTWARE LIMITED, London (UK)

(21) Appl. No.: 10/596,582

(22) PCT Filed: Dec. 16, 2004
(86) PCT No.: PCT/GB04/05281

§ 371 Date: Nov. 16, 2006

(30) Foreign Application Priority Data
Dec. 17, 2003 (GB) GB 0329283.6

(51) Int. Cl. G06F 17/30

(52) U.S. Cl. 707/10

(57) ABSTRACT

A first computing device in the form of a mobile phone is used to initiate a comparison of the entries stored in a contacts store associated with the first device with the entries stored in a contacts store associated with a second device. Mutual contacts are then advised to the second device. Digests of the contacts stores entries may be used to make the comparison. Communication may be directly between the devices, such as by using Bluetooth, or may be via a network operator. The respective contacts stores may be held on the devices or by the network operator. The network operator may be used to make the comparison of store entries.

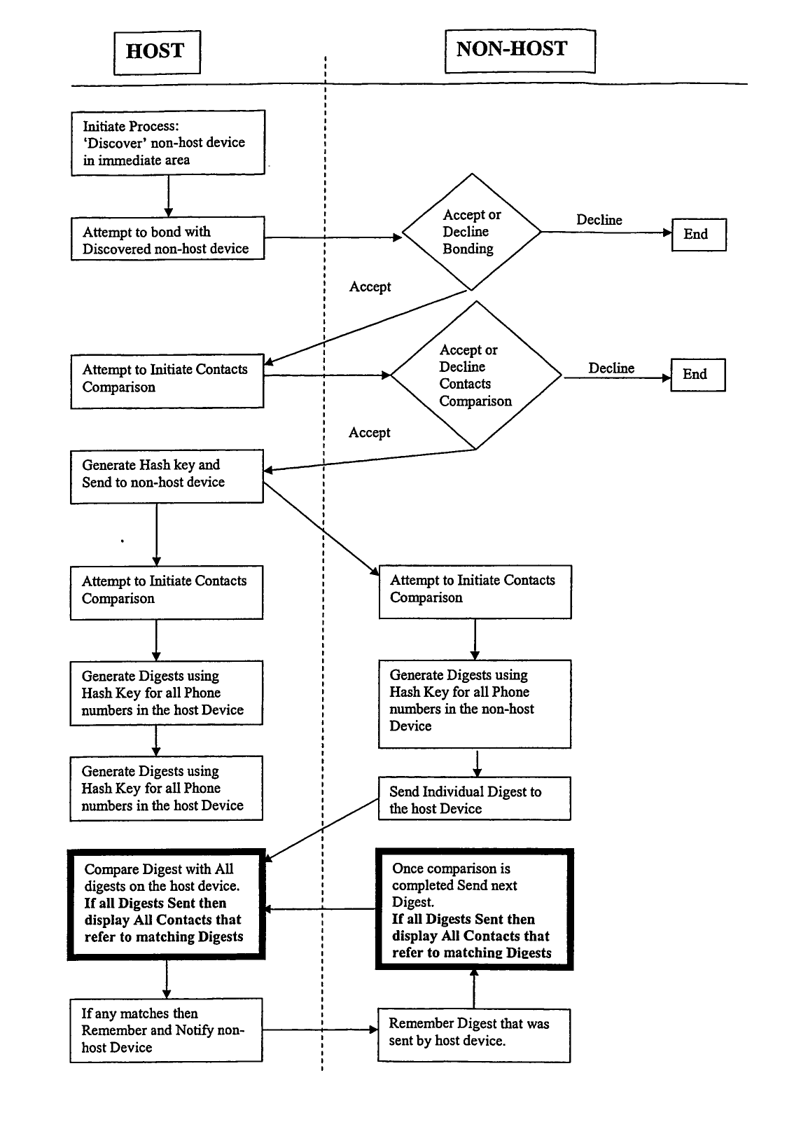

The present invention relates to a method for communicating information between computing devices, and in particular, to a method for communicating common entries in contacts stores between computing devices. The present invention also relates to a computing device arranged to operate in accordance with the above method and also to computer software for causing a computing device to operate in accordance with the above method.

It has been recognised for some time that social networks exhibit the ‘small world’ phenomenon, first described by Stanley Milgram in ‘The Small World Problem’ (Psychology Today, 1967). Stanley Milgram was a Harvard social psychologist who, in the late nineteen-sixties, conducted an experiment to try to determine how human beings are connected socially. Do human beings belong to separate worlds, operating simultaneously but autonomously, so that the links between any two people, anywhere in the world, are few and distant: or are human beings all bound up together in a grand, interlocking web?

Milgram tested these questions with a chain letter mailed to each of a number of people, selected at random, from a particular US town in Nebraska. The letter contained the name and address of a stockbroker who worked in Boston and lived in Sharon, Mass. Each person was instructed to write his name on a roster enclosed with the letter and send it on to a friend or acquaintance who he thought would be closer to the stockbroker. The idea was that when the letters finally arrived at the stockbroker's house the roster of names would establish how closely connected someone chosen at random from one part of the country was to another person chosen at random in another part. It was found that most of the letters reached the stockbroker in five or six steps and this has given rise to the concept now widely known as the six degrees of separation.

Most groups of human beings do not have particularly diverse groups of friends so the findings of Milgram are rather surprising. Six degrees of separation does not simply mean that everyone is linked to everyone else in just six steps. It means that a very small number of people are linked to everyone else in a few steps, and the rest of us are linked to the world through those few.

The essence of the small world phenomenon described above is not just the now-familiar dictum that everyone can be connected to everyone else through, on average, six degrees of separation; it also incorporates the insight that this applies irrespective of the size of a society, and the key enabling mechanism is that social networks consist of clusters of acquaintances, with a relatively small number of key individuals who are instrumental in linking these clusters together.

The informal application of the small world properties of social networks, and in particular the identification of those key individuals who link separate clusters of acquaintances, is something that most people practise instinctively whenever they meet strangers in a common social or business context; an initial conversation almost always turns to a “Do you know . . . ” enquiry sooner rather than later. In fact, the initial exchanges in a conversation between strangers are often directed at identifying the likeliest individual who might be a mutual acquaintance.

The verbal method of establishing mutual acquaintances as referred to above has, therefore, a number of limitations. It is better suited to people who are confident in any social situation rather than to those who suffer from shyness in unfamiliar surroundings. There can be some awkwardness attached to breaking off a conversation when no mutual acquaintances can be identified, and also when one is found who has negative connotations for one party but not the other. It can take a significant amount of time. The verbal establishment of contacts is also unpredictable, and depends to a large extent on the initial exploratory questions. This means that the verbal approach often finds to fail significant mutual acquaintances where these cannot be uncovered by obvious or easy questions.

With the present invention it has been realized that establishing mutual contacts is the easiest route to the establishment of any interpersonal relationships in both personal contexts (parties and other social gatherings) and business contexts (such as conventions, exhibitions and interviews) that bring strangers together. Thus, it is an object of the present invention to provide an improved method for establishing mutual contacts within a social group existing either in a business or a personal context.

According to a first aspect of the present invention there is provided a method of communicating information between first and further computing devices, each having a communications capability, the method comprising comparing contact entries of a first contact store accessible by the first device and a further contact store accessible by the further device, and notifying at least one of the devices of contacts determined to be common to the first and further contact stores.

According to a second aspect of the present invention there is provided a computing device arranged to operate in accordance with a method according to the first aspect.

According to a third aspect of the present invention there is provided computer software for causing a computing device according to the second aspect to operate in accordance with a method according to the first aspect.

An embodiment of the present invention will now be described, by way of further example only, with reference to the accompanying drawing which illustrates a flow chart of a method for exchanging contacts information in accordance with an embodiment of the present invention.

Despite the amount of contact data that people are increasingly carrying inside computing devices such as mobile phones, personal organisers and laptop computers, there has to date been no method described for automating the identification of mutual contacts who can link strangers belonging to different clusters in a social network.

The term computing device as used herein is to be expansively construed to include, data recording devices of any form factor, computers of any type or form, including hand held and personal computers, and communication devices of any form factor, including mobile phones, smart phones, communicators which combine communications, image recording and/or playback, and computing functionality within a single device, and other forms of wireless and wired information devices.

Modeling the mathematical properties of social networks is now being formally applied to areas as apparently diverse as viral marketing techniques and forensic science, and there is a well established body of work covering the mining of large databases held on corporate computers that relates to uncovering this type of information. However, this work is undertaken primarily for commercial and marketing uses, and importantly, is generally undertaken without the cooperation and sometimes even the knowledge of the subjects. It therefore requires heavyweight inductive techniques that do not scale to handheld personal devices with limited resources.

Many people now hold information concerning acquaintances on mobile computing devices such as personal organisers, mobile telephones and portable computers. This information is typically kept in some type of address book or contacts store with database-like characteristics. With the present invention it has been realised that if two parties cooperate in comparing all or part of the contents of their contacts stores, an automated process enabling the discovery of the mutual acquaintances of both parties becomes possible. Modern techniques of mobile wireless personal area networking and communication, such as Bluetooth, Infrared, 802.11 WiFi, and public cellular wireless telephony, make this sharing of contacts store information especially convenient, economical and practical.

A basic scenario may run as follows: Two people, with computing devices such as smart phones that store their contacts information and have short range connection ability, are present at an event. With their smart phones enabled to compare contacts store information, the devices securely compare their respective contacts stores, and then display common entries to the users of each device.

There are a number of useful refinements to this basic scenario:

People could be granted the ability to make any one or more individual contacts “private” and therefore exempt from mutual contact discovery. Additionally, a contacts store could be separated into contact groups depending for example, on the social context, so that only selective subsets of the contacts would be compared; for instance personal contacts, business contacts.

It is clearly possible for items relating to a single entry in a contacts store to be different, yet still correspond to the same entity. For example, it is not unlikely that a match for a common name such as John Smith might actually relate to two different people. However, there are some contact fields that should be unique to a single entry in the contacts store; email addresses and telephone numbers are candidates. For a mobile phone, more contacts are likely to have a unique telephone number than any other contact identifier. Thus, in a preferred embodiment of the invention phone numbers are selected as the contact identifier field for the comparison between contacts stores entries.

However, it should be appreciated that other contacts fields may be more useful in certain situations. For example, a staff member from the UK division of multinational company AAA attends an international business event and it is company policy that when attending such events the mobile phones of company AM attendees are enabled to share business contacts store information. In this instance the address field may be selected to compare contacts, searching for the sequence AAA within the address field. In this way any staff member of multinational company AAA can determine whether another staff member from any division of company AAA, such as the US division, is present at the event. The staff members can then communicate and arrange to meet.

In the preferred form of the invention using phone numbers, all phone numbers stored in one device (one contact may have more than one phone number) should be compared with all numbers in the other. A single phone number can be represented a number of ways and as a result different devices can hold the same number in different ways. Some degree of normalization can be enforced by stripping out padding and separator characters such as spaces, brackets and hyphens, which are not part of the phone number itself. The main remaining reason why the same number may be represented differently in different devices is likely to be whether optional area or country codes are included. Where two devices include databases of these optional codes, it is envisaged to normalize the numbers still further by enforcing their addition, with a leading + sign being used as a country code prefix. Where devices do not include such country and area code databases, comparing telephone numbers may miss some common contacts where owners have used different conventions for entering numbers. However, users can avoid this by ensuring that that they enter numbers which conform to an accepted standard such as ITU-T Recommendation E.123.

To initiate the process one device owner would locate the other. In a bluetooth scenario this could be done via Service Discovery Profile. Once the correct device had been identified it should be bonded to. Again in a bluetooth scenario this would correspond to pairing with the device. Once paired there should some menu option to initiate the contact comparison. The device that has been ‘found’ (the ‘non-host’) preferably receives some form of notification of the pairing and the option to accept or decline taking part in the process.

The device that has initiated the search (the ‘host’) for the other then generates a Hash key. The one-way hash function used can be determined by the host. However, due to the number of times the function is likely to be called (once for each phone number stored in each phone) then computational efficiency may be regarded to take priority over maximum security.

The Hash key is then exchanged between devices. On exchange, each device generates a digest using each phone number and the key according to the chosen algorithm. Each phone then stores its respective digests. The length of each digest is preferably kept to a minimum, since it is likely that a relatively large number of transfers will take place between the host and non-host devices (again, once for each phone number stored in each device).

When the non-host device has completed a digest for each contact, these digests are sent, in turn, to the host device. The host then compares each received digest with the list of digests it has generated and stored. If there is any match between received and stored digests then the digest in question is remembered and a message is sent to the non-host advising that the digest is to be remembered also by the non-host device. Once all digests from the non-host device have been sent then the devices display to the respective users all contacts that correspond to the remembered digests. The process according to this embodiment of the invention is shown in the accompanying drawing.

In an alternative embodiment of the invention the process can be revised so that instead of a direct device to device comparison, the comparison is carried out over a cellular network. An example of this network comparison may be as follows.

The process is initiated by having the other party (the non-host) to the process as a contact in the device of the party (the host) initiating the process. A menu option is provided which, when selected, invites a contact in the device to partake in the process. When this menu option is selected, the non-host receives a notification that the host is seeking to initiate the process and inviting participation by the non-host, which may either be accepted or declined.

Instead of one of the devices generating the hash key, as in the direct device to device contacts sharing described above, a network server assumes responsibility to generate the key and transmits this key to both devices. The devices then generate their digests as in the above device to device process. Then, the non-host device sends its digests one-by-one to the network. The network then sends the digests to the host device for comparison with the digests generated and stored locally in the host device. If there is a matching digest then this information is passed back to the network and then from the network the non-host device. The process is then the same as described above for direct device to device communication.

If the contacts for the devices have been synchronised with the network (i.e. both devices contacts entries are also stored on the network) then the digest generation and comparison can be carried out by the network and not within the devices. However this procedure requires some form of secure communication from the networks to the devices to identify which are the matching contacts.

The present invention is considered to provide the following advantages
It is quicker and more efficient than the conversational method; it reduces the time it takes to establish common connections.
It is more thorough; it enables common acquaintances to be found where the context of the meeting between strangers is such that a conversational approach may be difficult to establish.
It is more flexible; it can work in situations where conversational approaches are not possible. Examples are noisy parties, during speeches at conventions, where two strangers do not have sufficient proficiency in a common language.
It is more socially neutral; people who are shy and find it difficult to enter into exploratory conversations with strangers are more likely to be happy with delegating the task to an electronic aid.

Although the present invention has been described with reference to particular embodiments, it will be appreciated that modifications may be effected whilst remaining within the scope of the present invention as defined by the appended claims.

1. A method of operating a computing device which enables the communication of information between the device and a further computing device, each having a communications capability, the method comprising causing the device to request information regarding contact entries in a contact store accessible by the further device, comparing contact entries of a first contact store accessible by the device with contact entries made available to the device from the contact store accessible by the further device, and notifying at least one of the devices of contacts determined to be common to the first and further contact stores.

2. A method according to claim 1 wherein the contact store of the device and/or the contact store of the further device is/are arranged as a plurality of overlapping or exclusive groups of contact entries.

3. A method according to claim 1 wherein contact entries in the contact store of the device and/or the contact store of the further device are selectively excluded from the comparison of contact entries.

4. A method according to claim 3 wherein at least one of the groups is selectively excluded from the comparison of contact entries.

5. A method according to claim 1 wherein the contact entries are selected to comprise telephone numbers.

6. A method according to claim 5 wherein selected characters are removed from the telephone numbers.

7. A method according to claim 6 wherein the telephone numbers are arranged to comprise a country or area code.

8. A method according to claim 1 wherein the contact entries comprise digests of part or all of contacts in the contact stores accessible by the device and the further device.

9. A method according to claim 8 wherein the digests include a hash key known to the device and the further device.

10. A method according to claim 9 wherein one of the computing devices is arranged to generate the hash key and communicate it to the other device.

11. A method according to claim 9 wherein a network server is arranged to generate the hash key and communicate it to the devices.

12. A method according to claim 1 wherein the comparison of contact entries is undertaken by one of the computing devices using data communicated to it by the other.

13. A method according to claim 1 wherein the comparison of contact entries is undertaken by a network server.

14. A method according to claim 1 wherein the contacts store accessible by the device and the contacts store accessible by the further device are held respectively on the device and the further device.

15. A method according to any one of claims 1 wherein the contacts store accessible by the device and the contacts store accessible by the further device are held by a third party.

16. A method according to claim 15 wherein the third party comprises the network server.

17. A method according to claim 1 wherein communication between the device and further device occurs over a wireless link.

18. A method according to claim 17 wherein the wireless link comprises any one or more of a cellular phone network, infrared, Bluetooth or a 802.11 WiFi network.

19. A method according to claim 1 wherein communication between the device and the further device occurs over a wired link.

20. A method according to claim 19 wherein the wired link comprises any one or more of Ethernet, Cable, Telephone, and Serial.

21. A computing device arranged to operate in accordance with a method as claimed in claim 1.

22. A computing device according to claim 21 comprising a mobile phone.

23. Computer software arranged to cause a computing device as claimed in claim 21 to operate in accordance with a method as claimed in claim 1.
